(19) United States
(12) Patent Application Publication
(10) Pub. No.: US 2005/0266870 A1
(43) Pub. Date: Dec. 1, 2005

(54) Network support for broadcast calling from a wireless phone

(76) Inventors: David S. Benco, Winfield, IL (US); Kevin J. Overend, Elmhurst, IL (US); Baoling S. Sheen, Naperville, IL (US); Sandra Lynn True, St. Charles, IL (US); Kenneth J. Voight, Sugar Grove, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(21) Appl. No.: 10/854,840

(22) Filed: May 27, 2004

(51) Int. Cl. H04B 7/00

(52) U.S. Cl. 455/519; 455/415

(57) ABSTRACT

A method for supporting a broadcast call feature (BCF) (50) is provided for a mobile station (MS) (10) served by a wireless telecommunications network. The method includes: receiving a signal from the MS (10) requesting use of the BCF (50); prompting the MS (10) for a message; recording the message; cueing-up a plurality of telephone numbers in a cue (58); dialing a telephone number from the cue (58) to establish a connection with a called party corresponding to the dialed telephone number; and, playing back the recorded message to the called party when a connection is established therewith.

### FIELD

The present inventive subject matter relates to the telecommunication arts. Particular application is found in conjunction with wireless mobile devices (e.g., mobile telephones and the like), and the specification makes particular reference thereto. However, it is to be appreciated that aspects of the present inventive subject matter are also amenable to other like applications.

### BACKGROUND

In certain instances, a wireless telephone service subscriber would benefit from the ability to quickly and efficiently contact multiple parties in order to deliver or otherwise communicate important information to the parties either simultaneously or nearly simultaneously. For example, an individual holding a meeting may want to inform a group of attendees of a change in the location of the meeting, the time of the meeting, or other changes in plans.

One option to achieve the foregoing goal would be for the calling party to place separate calls to each of the individual called parties. This option however has certain drawbacks due to the fact that multiple calls are being made. First, it can be unduly time consuming to place multiple calls, especially if there are many called parties to be contacted. This is obviously disadvantageous to a busy professional or other individual. Second, multiple calls proportionally increase the amount of air time usage and/or charges incurred under the calling party's wireless telephone service plan. Again, the added usage of air time minutes and/or additional costs associated with multiple calls is disadvantageous. Third, to ensure that all the parties receive the information desired to be communicated, the calling party may have to keep track of which called parties were ultimately reached and which were not so that those not reached can be called again at a different time. This can also be a disadvantageous burden on the calling party.

Another option to achieve the foregoing goal would be for the calling party to place a conference call to all the called parties. This however can be impractical and burdensome if there is a significant number of called parties. One drawback is that all the called parties would have to be available to participate in the conference call simultaneously in real time. That is to say, a called party would have to receive the information in person, as opposed to receiving it by way of voicemail or an answering machine. Additionally, it can be time consuming dialing each called party individually, not only for the calling party, but the earlier called parties would also have to wait as each additional party to be added to the conference call is called.

Accordingly, a new and improved broadcast calling feature is disclosed that overcomes the above-referenced problems and others.

### SUMMARY

In accordance with one preferred embodiment, a method for supporting a broadcast call feature (BCF) is provided for a mobile station (MS) served by a wireless telecommunications network. The method includes: receiving a signal from the MS requesting use of the BCF; prompting the MS for a message; recording the message; cueing-up a plurality of telephone numbers in a cue; dialing a telephone number from the cue to establish a connection with a called party corresponding to the dialed telephone number; and, playing back the recorded message to the called party when a connection is established therewith.

In accordance with another preferred embodiment, a system provides a BCF for an MS served by a wireless telecommunications network. The system includes: means for receiving a signal from the MS requesting use of the BCF; means for prompting the MS for a message; means for recording the message from the MS; means for cueing-up a plurality of telephone numbers in a cue; means for dialing telephone numbers from the cue to establish connections with called parties corresponding to the dialed telephone numbers; and, means for playing back the recorded message to the called parties when connections are established therewith.

In accordance with yet another preferred embodiment, a mobile switching center (MSC) supports a BCF for an MS served by a wireless telecommunications network. The MSC includes: a recorder that records a message obtained from a calling party using the MS to implement the BCF; a cue into which is loaded a plurality of telephone numbers; a dialer that dials the telephone numbers accessed from the cue to establish connections with called parties corresponding to the telephone numbers; and, a message player that plays the message obtain from the calling party to those called parties with which connections have been established.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagrammatic illustration of an exemplary telecommunications network suitable for practicing aspects of the present inventive subject matter.

FIG. 2 is a box diagram showing an exemplary broadcast calling feature embodying aspects of the present inventive subject matter.

FIG. 3 is a flow chart showing an exemplary process for carrying out a broadcast call in accordance with aspects of the present inventive subject matter.

### DETAILED DESCRIPTION OF PREFERRED EMBODIMENTS

For clarity and simplicity, the present specification shall refer to structural and/or functional elements, entities and/or facilities, relevant communication standards, protocols and/or services, and other components that are commonly known in the telecommunications art without further detailed explanation as to their configuration or operation except to the extent they have been modified or altered in accordance with and/or to accommodate the preferred embodiment(s) presented.

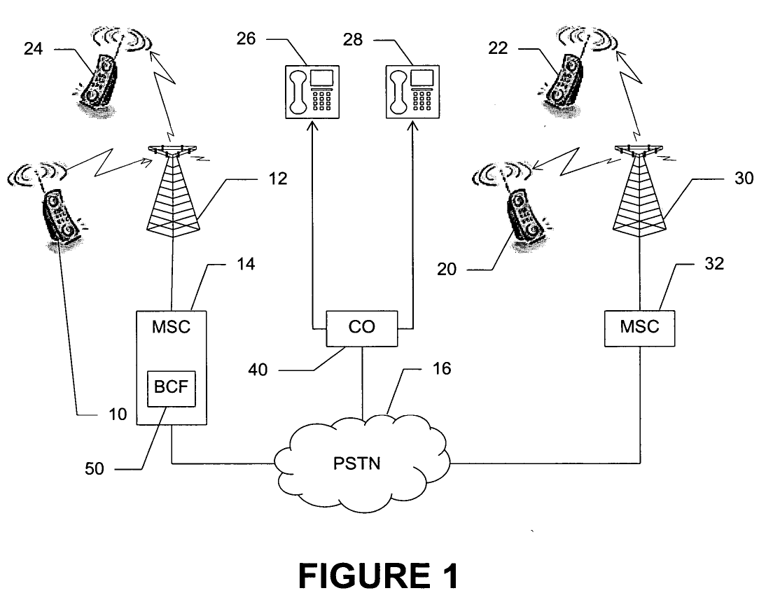

With reference to FIG. 1, a calling party uses a wireless mobile telecommunications device or mobile station (MS) 10 to initiate a broadcast call to a plurality of called parties. The MS 10 (e.g., a mobile telephone or other wireless mobile end user equipment) selectively connects with a wireless telecommunications network via a base station (BS) 12 served by a mobile switching center (MSC) 14 that connects to the public switched telephone network (PSTN) 16 in the usual manner. Suitably, the MS 10 is provisioned with the usual elements, e.g., a keypad with traditional numeric keys, soft keys, navigation keys, etc.; a liquid crystal display (LCD) or other such display; and, other components commonly found on and/or incorporated in an MS. The MSC 14 supports a broadcast call feature (BCF) 50 as described below.

As shown in the present example, the called parties include MS 20, MS 22 and MS 24, and landline customer premises equipment (CPE) 26 and 28, e.g., landline telephones, answering machines or the like. The MS 20 and MS 22 selectively connect with the wireless telecommunications network via BS 30 served by MSC 32 that connects to the PSTN 16 in the usual manner. Like the calling party's MS 10, MS 24 selectively connects with the wireless telecommunications network via the BS 12 served by the MSC 14 that connects to the PSTN 16. Landline CPE 26 and 28 are served by a central office (CO) 40 operatively connected to the PSTN 16 in the usual manner. However, while this particular example is being used for illustrative purposes herein, any of a variety of different combinations of similarly situated end users within a similar telecommunications network, including more or less than those shown, may collectively compose the plurality of called parties.

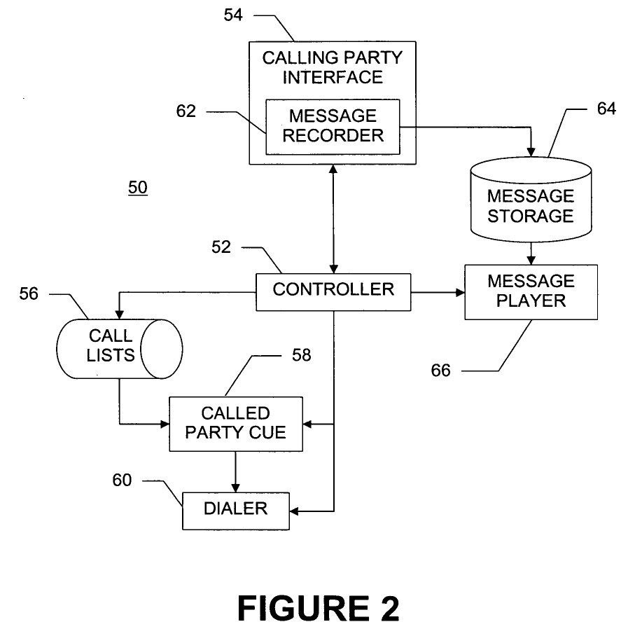

With reference to FIG. 2, the BCF 50 includes a controller 52 that regulates its operation and administers the feature. A calling party interface 54 provides prompting to and receives input from the MS 10 employing the BCF 50 at the MSC 14. Suitably, predefined call lists are stored in a database 56. The predefined call lists are optionally set up by the calling party to include the telephone numbers of called parties to which broadcast calls are frequently made. For example, one predefined call list may include all the telephone numbers of the calling party's family, anther may include all the telephone numbers of a the calling party's company, or of a particular business unit within the company, etc.

The telephone numbers to be dialed in a broadcast call are suitably stored or buffered in a called party cue 58, and a dialer 60 access the same to dial the telephone numbers. Suitably, the BCF 50 also includes a message recorder 62 that is optionally part of the calling party interface 54. The recorder 62 records the message (suitably, a voice or audible message) to be broadcast from the calling party and stores it in a message storage location 64, e.g., on a memory, hard drive, other electromagnetic or optical storage device, etc. A message player 66 retrieves the message from storage and plays the message to called parties when connections are established therewith.

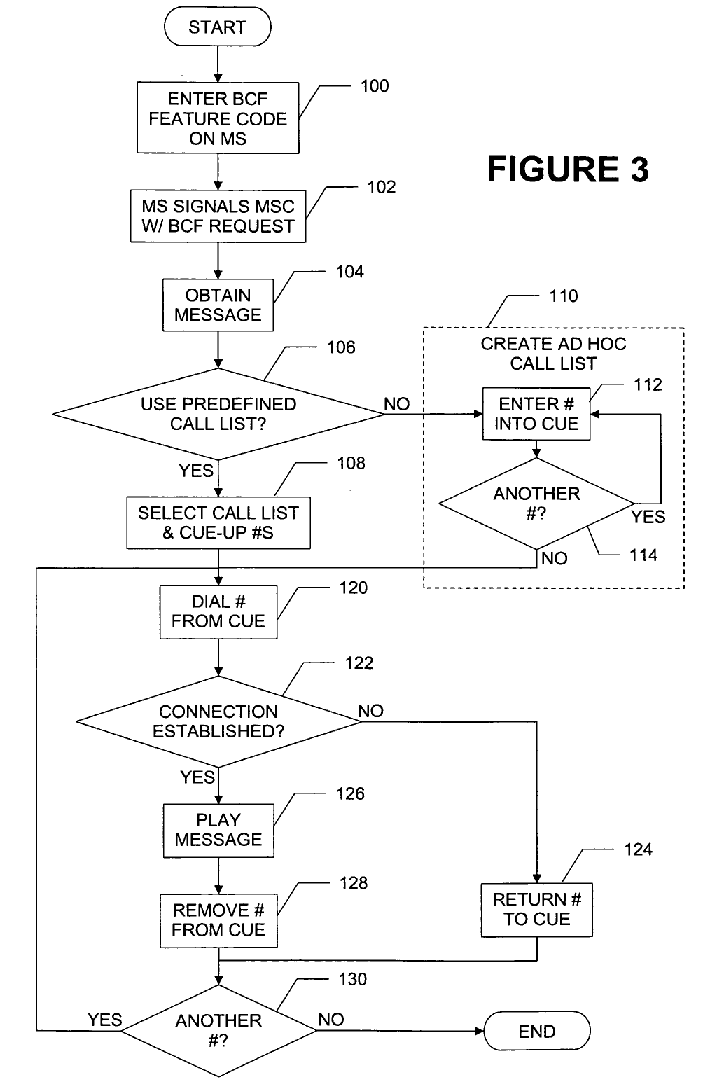

With reference to FIG. 3, to place a broadcast call, the calling party selects the broadcast call feature with the MS 10, e.g., by dialing a feature code or otherwise entering an appropriate input (step 100). The MSC 14 receives a signal from the MS 10 that the broadcast call feature is being requested (step 102). The calling party is then prompted by the BCF 50 (via interface 54) to record a message, e.g., “after the beep”, and the BCF 50 (via recorder 62) records the message (step 104). The calling party is then given the option to use a predefined call list (e.g., from database 56), or create an ad hoc call list (decision step 106). If the calling party opts for a predefined call list, they may select from a plurality of such lists (step 108), each list containing the telephone numbers of the called parties in the list. The telephone numbers from the selected list are then cued-up in the called party cue 58.

Alternately, if the calling party opts not to use a predefined call list, an ad hoc call list is created (step 110). To create the ad hoc call list, the calling party enters a telephone number that is placed in the called party cue 58 (sub-step 112). The calling party is then given the option to add another telephone number to the ad hoc call list (sub-step 114). If another telephone number is to be added to the ad hoc call list, the process loops back to sub-step 112, otherwise, the ad hoc call list is completed with each telephone number entered in sub-step 112 being cued-up in the called party cue 58.

At step 120, the dialer 60 dials a telephone number from the cue 58. Next, at decision step 122, it is determined if a connection has been established with the called party at the telephone number dialed. If not, i.e., if no connection is established, then the dialed telephone number is returned to the cue, e.g., at the end thereof (step 124), and the process continues to step 130 so that the next number in the cue may be dialed or the process ended as the case may be. In this manner, the telephone number will continue to be dialed until a connection is established. Optionally, there may be some delay imposed before telephone numbers returned to the cue are redialed, e.g., 5 to 10 or some other number of minutes. Accordingly, a busy number will not be called back immediately, for example. Additionally, telephone numbers may only be returned to the cue a limited number of times, e.g., such that the telephone number is only dialed 3 or 4 or some other set number of times before giving up efforts to establish a connection.

If, on the other hand, a connection is established with the called party at the telephone number dialed, then the message is played over the established connection by the message player 66 (step 126). Notably, when the connection is established with a called party's answering machine or voicemail or the like, the message is simply recorded by called party's device or service. In this manner, whether or not the call is answered in person or by an answering machine or voicemail or the like, the message is delivered or otherwise communicated to the called party. Having delivered or otherwise communicated the message to the called party, the dialed telephone number is removed from the cue (step 128).

At step 130, it is determined if there is another telephone number in the cue 58. If no, i.e., if there are no more telephone numbers in the cue 58 to be dialed, then the process ends, otherwise, if yes, i.e., there are more telephone numbers in the cue 58 to be dialed, then the process loops back to step 120 to dial the next telephone number in the cue 58.

While the particular example in FIG. 3 shows the message being recorded prior to selection of a predefined call list and/or creation of and ad hoc call list and prior to cueing the telephone numbers for the called parties, optionally, the call list selection and/or creation and/or the cueing of telephone numbers may take place before the recording of the message. Furthermore, optionally, certain steps are carried out in parallel. That is to say, by utilizing multiple lines, the BCF 50 can begin dialing the next telephone number in the cue 58 on a second line even before the prior iteration, conducted on a first line, is complete. Provided there is access to a sufficient number of lines (i.e., at or near as many as there are telephone numbers to be dialed), then the call may be broadcast to all the called parties simultaneously or nearly simultaneously. To further enhance parallel processing, additional dialers 60 are also optionally employed so that multiple numbers from the cue 58 are dialed simultaneously or nearly simultaneously.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

1. A method for supporting a broadcast call feature (BCF) for a mobile station (MS) served by a wireless telecommunications network, said method comprising:
(a) receiving a signal from the MS requesting use of the BCF;
(b) prompting the MS for a message;
(c) recording the message;
(d) cueing-up a plurality of telephone numbers in a cue;
(e) dialing a telephone number from the cue to establish a connection with a called party corresponding to the dialed telephone number; and,
(f) playing back the recorded message to the called party when a connection is established therewith.

2. The method of claim 1, further comprising:
(g) repeating steps (e) and (f) with successive telephone numbers from the cue.

3. The method of claim 2, wherein if the recorded message has been played back to a called party at their dialed telephone number, then that telephone number is removed from the cue.

4. The method of claim 2, wherein if a connection is not established with a called party at their dialed telephone number, then that telephone number is returned to the cue.

5. The method of claim 1, wherein the message is an audible message.

6. The method of claim 1, wherein step (d) includes:
obtaining the telephone numbers from a predefined call list.

7. The method of claim 1, wherein step (d) includes:
obtaining the telephone numbers from the MS on an ad hoc basis.

8. A system that provides a broadcast call feature (BCF) for a mobile station (MS) served by a wireless telecommunications network, said system comprising:
means for receiving a signal from the MS requesting use of the BCF;
means for prompting the MS for a message;
means for recording the message from the MS;
means for cueing-up a plurality of telephone numbers in a cue;
means for dialing telephone numbers from the cue to establish connections with called parties corresponding to the dialed telephone numbers; and,
means for playing back the recorded message to the called parties when connections are established therewith.

9. A mobile switching center (MSC) supporting a broadcast call feature (BCF) for a mobile station (MS) served by a wireless telecommunications network, said MSC comprising:
a recorder that records a message obtained from a calling party using the MS to implement the BCF;
a cue into which is loaded a plurality of telephone numbers;
a dialer that dials the telephone numbers accessed from the cue to establish connections with called parties corresponding to the telephone numbers; and,
a message player that plays the message obtain from the calling party to those called parties with which connections have been established.

10. The MSC of claim 9, further comprising:
a storage location in which the recorded message is stored and from which the message player obtains the message.

11. The MSC of claim 9, further comprising:
a database which contains one or more predefining call lists, each call list containing a plurality of telephone numbers that are selectively loaded into cue.

12. The MSC of claim 9, wherein if the message has been played to a called party at their dialed telephone number, then that telephone number is removed from the cue.

13. The MSC of claim 9, wherein if a connection is not established with a called party at their dialed telephone number, then that telephone number is returned to the cue.

14. The MSC of claim 9, wherein the cue is loaded with telephone numbers obtained from the calling party on an ad hoc basis.

15. The MSC of claim 9, including a plurality of dialers that substantially simultaneously dial different telephone numbers accessed from the cue.
